(19) United States
(12) Patent Application Publication
(10) Pub. No.: US 2022/0173522 A1
(43) Pub. Date: Jun. 2, 2022

(54) REFLECTOR ANTENNA SYSTEM AND METHOD FOR MANUFACTURE

(71) Applicant: ViaSat, Inc., Carlsbad, CA (US)

(72) Inventors: Kurt A. Zimmerman, Dunwoody, GA (US); Jack C. Newkirk, Woodstock, GA (US)

(21) Appl. No.: 17/599,534

(22) PCT Filed: Mar. 27, 2020
(86) PCT No.: PCT/US2020/025428

§ 371 Date: Sep. 28, 2021

Related U.S. Application Data
(60) Provisional application No. 62/826,531, filed on Mar. 29, 2019.

(51) Int. Cl. H01Q 15/14; H01Q 15/16

(52) U.S. Cl. CPC H01Q 15/141; H01Q 15/165

(57) ABSTRACT

One example includes a method for assembling a reflector antenna. The method includes coupling first and second frame members to respective sidewalls of a panel bonding tool via fastening features to engage a through-hole pattern of each of the respective frame members and bend the frame members to form a perimeter frame. A longitudinal surface of each of the frame members corresponding to a reflector profile of the reflector antenna extends beyond a longitudinal surface of the respective sidewalls along a length of the respective sidewalls. The method also includes applying an adhesive to each of the frame members of the perimeter frame, and adhering a reflector skin to the perimeter frame to form a radial antenna panel. The radial antenna panel has the reflector profile. The method further includes decoupling the radial antenna panel from the panel bonding tool upon curing of the adhesive.

### RELATED APPLICATIONS

This application claims priority from U.S. Provisional Application No. 62/826,531, filed 29 Mar. 2019, which is incorporated herein by reference in its entirety.

### TECHNICAL FIELD

This disclosure relates generally to communication systems, and more specifically to a reflector antenna system and method for manufacture.

### BACKGROUND

Antennas that are designed to communicate long distances, such as to and from satellites, are designed to include a reflector that collimates or focuses an associated radio signal. Such reflector antennas are typically fabricated in panel portions that include a reflector skin formed of a light material (e.g., aluminum). The panel portions are typically aligned in such a manner as to attempt to optimize a parabolic profile, which can typically involve mechanical tuning of the coupling of the panel portions together. To manufacture a panel portion, the reflector skin is typically formed in a reflector profile, such as a parabolic reflector profile, to optimize the collimation or focusing of the radio signal. The reflector skin is typically coupled to a perimeter frame to maintain the reflector profile of the reflector skin, and the perimeter frames of the panel portions can be coupled together to form the reflector antenna.

### SUMMARY

One example includes a method for fabricating a radial antenna panel of a reflector antenna. The method includes coupling first and second frame members to respective sidewalls of a panel bonding tool via fastening features to engage a through-hole pattern of each of the respective frame members and bend the frame members to form a perimeter frame. A longitudinal surface of each of the frame members corresponding to a reflector profile of the reflector antenna extends beyond a longitudinal surface of the respective sidewalls along a length of the respective sidewalls. The method also includes applying an adhesive to each of the frame members of the perimeter frame, and adhering a reflector skin to the perimeter frame to form a radial antenna panel. The radial antenna panel has the reflector profile. The method further includes decoupling the radial antenna panel from the panel bonding tool upon curing of the adhesive.

Another example includes a reflector antenna system. The system includes a hub at an axial center of a reflector antenna, and a plurality of radial antenna panels each comprising a plurality of frame members and a respective reflector skin. Each of the frame members includes a through-hole pattern along a radial length of the respective frame member. The system further includes a plurality of ribs. Each of the ribs can be coupled to and radially extending from the hub and interconnecting a pair of the respective radial antenna panels. Each of the ribs includes a through-hole pattern along a length of the respective one of the ribs, such that each of the plurality of ribs interconnects the pair of the radial antenna panels via fastening hardware extending through the corresponding through-hole patterns of the respective rib and respective frame members. The corresponding through-hole patterns of the respective rib and respective frame members collectively define a reflector profile of the reflector antenna from the axial center to the periphery of the reflector antenna.

### BRIEF DESCRIPTION OF THE DRAWINGS

FIG. 1 illustrates an example of an antenna system.

FIG. 2 illustrates an example diagram of a radial antenna panel.

FIG. 3 illustrates an example diagram of a frame member.

FIG. 4 illustrates an example of a panel bonding tool.

FIG. 5 illustrates another example of a panel bonding tool.

FIG. 6 illustrates an example diagram of fabricating a radial antenna panel.

FIG. 7 illustrates another example diagram of fabricating a radial antenna panel.

FIG. 8 illustrates another example diagram of fabricating a radial antenna panel.

FIG. 9 illustrates another example diagram of fabricating a radial antenna panel.

FIG. 10 illustrates another example diagram of fabricating a radial antenna panel.

FIG. 11 illustrates an example of a rib of an antenna system.

FIG. 12 illustrates an example diagram of coupling of radial antenna panels to a rib.

FIG. 13 illustrates an example of a method for fabricating a radial antenna panel of a reflector antenna.

### DETAILED DESCRIPTION

This disclosure relates generally to communication systems, and more specifically to a reflector antenna system and method for manufacture. A reflector antenna system is formed of a plurality of radial antenna portions. Each of the radial antenna portions is formed from a pair of frame members and a reflector skin, and is fabricated using a panel bonding tool. The panel bonding tool can include a pair of sidewalls having fastening features that are arranged in a reflector profile of the reflector antenna. As described herein, the term “reflector profile” describes a cross-sectional radial profile of the reflector of the reflector antenna system. For example, the reflector profile can be a parabolic antenna, such as corresponding to a main reflector or a sub-reflector of an antenna (e.g., a Cassegrain antenna). For example, the reflector profile can be any of a variety of contours, such as concave, convex (e.g., for a sub-reflector), or flat.

To fabricate a radial antenna panel, the frame members are secured to the sidewalls of the panel bonding tool via the fastening features. For example, the fastening features can be arranged as sliding pins (e.g., spring-mounted) that can engage with through-holes (e.g., through-hole slots) along a length of the respective frame members. The frame members can be configured as an extruded material that is selected for stiffness, but can include kerf slits arranged periodically along a longitudinal length, such that the frame members can be bent to form the reflector profile along a surface of the respective frame members. The frame members can therefore be included as part of a perimeter frame (e.g., also including interconnecting members between the respective frame members) that is associated with the radial antenna panel and formed on the panel bonding tool. An adhesive can be applied to the respective surfaces of the frame members, and the reflector skin can be applied to the adhesive. For example, the panel bonding tool can include clamps that can be applied to provide pressure to the reflector skin onto the frame members during curing of the adhesive.

The radial antenna panel can then be removed from the panel bonding tool and can be coupled to one of a respective plurality of ribs coupled to a hub defining an axial center of the reflector antenna. For example, each of the radial antenna panels can be coupled between a pair of ribs, such that each rib supports a pair of radial antenna panels. For example, the through-holes associated with the frame members can facilitate coupling to a through-hole pattern associated with the respective rib, such that a given bolt can pass through a frame member associated with a first radial antenna panel, the respective rib, and a frame member associated with a second radial antenna panel. The through-hole pattern of the respective rib can be approximate the same as the fastening feature pattern of the sidewalls of the panel bonding tool, such that the through-hole pattern of the rib can exhibit the reflector profile of the reflector antenna. For example, the through-hole pattern of the frame members can include a precision through-hole that is most proximal to the hub to radially align the radial antenna panels for optimal metrology of the reflector antenna. The remaining through-holes extending longitudinally along the frame members can correspond to through-hole slots to accommodate thermal effects (expansion and contraction) affecting the radial antenna panel.

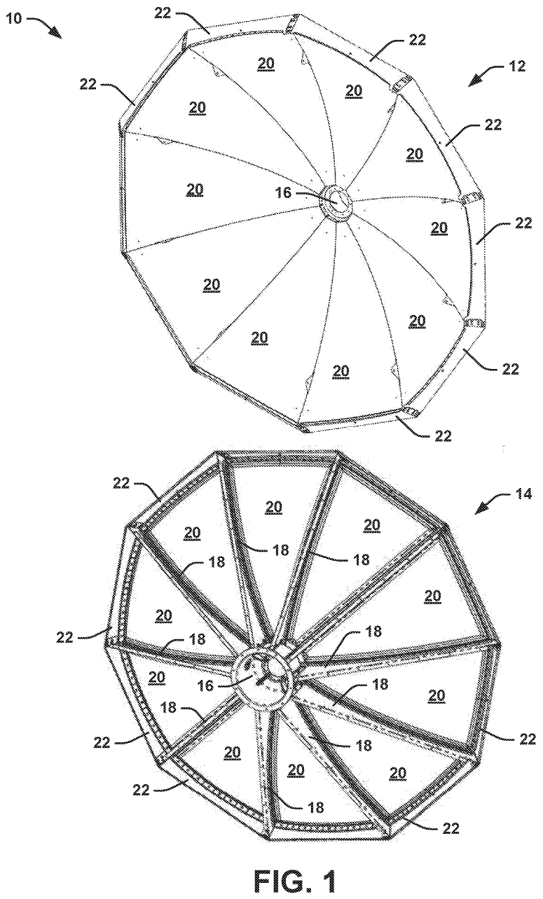

FIG. 1 illustrates an example of an antenna system 10. The antenna system 10 is demonstrated in the example of FIG. 1 in a first isometric view 12 corresponding to an anterior view and in a second isometric view 14 corresponding to a posterior view. The antenna system 10 can be implemented in any of a variety of wireless communications applications that may require a focused or collimated beam, such as satellite communication system.

The antenna system 10 includes a hub 16 that defines an axial center of the antenna system 10, as well as a plurality of ribs 18 that are coupled to and radially extend from the hub 16. The plurality of ribs 18 are each also coupled to a respective plurality of radial antenna panels 20 that radially extend between adjacent ribs 18. Therefore, a given one of the ribs 18 can be coupled to an adjacent pair of the radial antenna panels 20. Each of the radial antenna panels 20 is demonstrated as including a perimeter band bracket 22. The perimeter band brackets 22 thus collectively surround the perimeter of the antenna system 10 and extend in the anterior direction of the antenna system 10. As an example, the perimeter band brackets 22 can provide greater structural strength to the antenna system 10, such as to maintain the reflector profile under wind and gravity loading conditions.

As described in greater detail herein, each of the radial antenna panels 20 can include a perimeter frame and a reflector skin that is coupled to the perimeter frame, where the reflector skin provides has a surface from which a given radio frequency (RF) signal is reflected for transmission and/or receipt of the RF signal. In the first isometric view 12, the radial perimeters of reflector skins of adjacent radial antenna panels 20 are demonstrated as approximately flush, such that the ribs 18 are substantially covered by the reflector skin of the respective radial antenna panels 20. Therefore, the anterior surface of the antenna system 10 is substantially smooth to mitigate diffraction of the RF signal that reflects from the anterior surface of the antenna system 10.

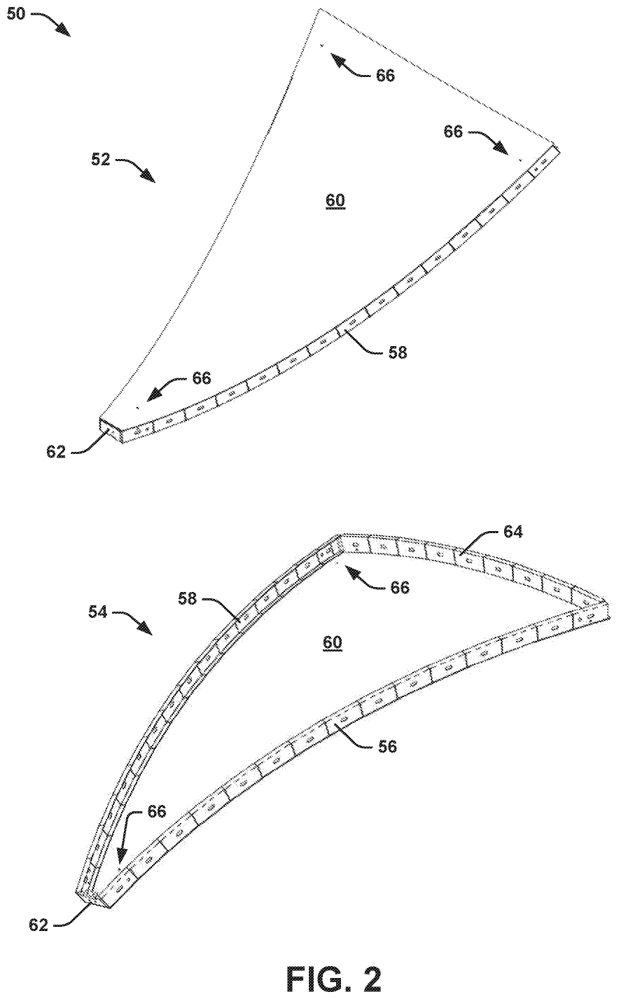

FIG. 2 illustrates an example diagram 50 of a radial antenna panel. In the example of FIG. 2, the radial antenna panel is demonstrated in an anterior view 52 and in a posterior view 54. The radial antenna panel can correspond to a given one of the radial antenna panels 20 in the example of FIG. 1. Therefore, reference is to be made to the example of FIG. 1 in the following description of the example of FIG. 2.

The radial antenna panel includes a first frame member 56, a second frame member 58, and a reflector skin 60. The first and second frame members 56 and 58 are each coupled to opposite edges of the reflector skin 60 and can be fabricated substantially identically, as described in greater detail herein. As an example, the reflector skin 60 can be formed in a variety of ways, such as stretch-formed or vacuum-formed. The radial antenna panel also includes a nose bracket 62 that interconnects the frame members 56 and 58 at a first end of the respective frame members 56 and 58 and a corner bracket 64 that interconnects the frame members 56 and 58 at a second end of the respective frame members 56 and 58 opposite the first end. The frame members 56 and 58 and the interconnect members 62 and 64 can collectively form a perimeter frame for the radial antenna panel to which the reflector skin 60 is coupled (e.g., via an adhesive, screws, or rivets) which extends therebetween. In the example of FIG. 2, the reflector skin 60 is demonstrated as include a set of three guide holes 66, as described in greater detail herein.

For example, the frame members 56 and 58, the interconnect members 62 and 64, and the reflector skin 60 can be formed from a light metallic material, such as aluminum. However, the frame members 56 and 58, the interconnect members 62 and 64, and the reflector skin 60 can alternatively be formed from a non-metal substrate material with a reflector coating (e.g., on only the anterior surface). For example, the non-metal substrate material can be a plastic material that can be solvent bonded, friction welded, or ultrasonic welded to form the radial antenna panel, and a a reflector coating can be applied to the anterior surface of the reflector skin 60 via soldering, TIG welding, spot welding, or any other method of bonding. For example, the choice of materials for the frame members 56 and 58, the interconnect members 62 and 64, and the reflector skin 60 can be selected to mitigate shrinkage/warpage, to affect final accuracy, weight, and/or stiffness of the radial antenna panel. As another example, the reflector anterior coating can be selected to effect electromagnetic performance.

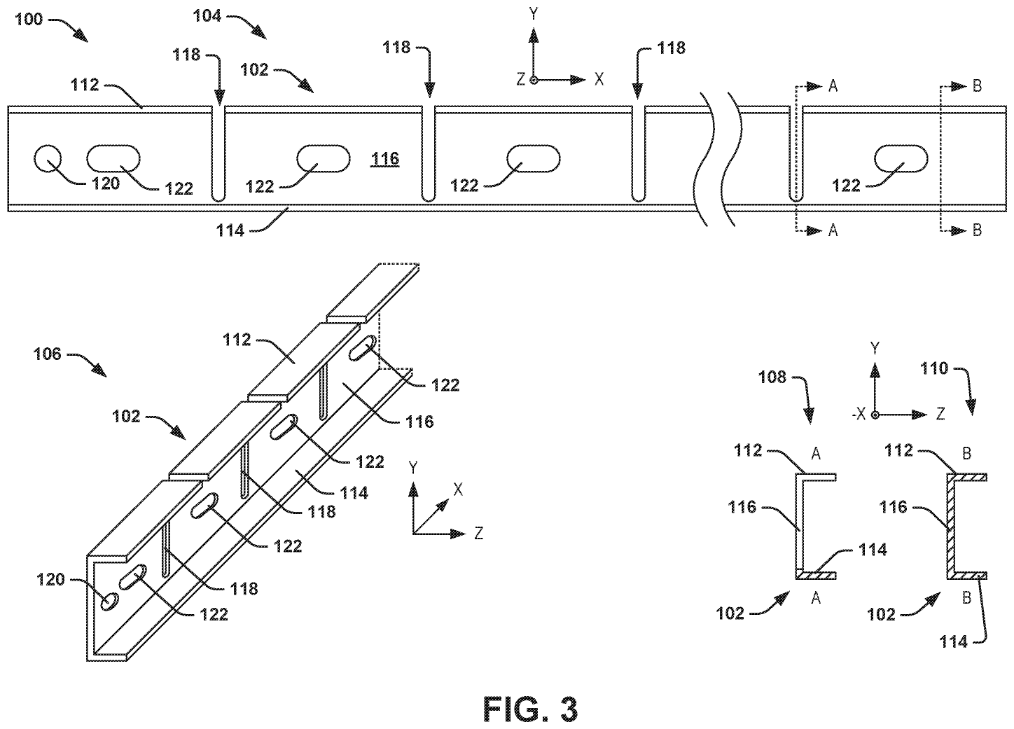

FIG. 3 illustrates an example diagram 100 of a frame member 102. The frame member 102 can correspond to a given one of the frame members 56 and 58 in the example of FIG. 2. As a result, the frame member 102 can correspond to one of two frame members that form an associated radial antenna panel. Therefore, reference is to be made to the example of FIG. 2 in the following description of the example of FIG. 3.

The frame member 102 is demonstrated in multiple views in Cartesian coordinate space in the example of FIG. 3. The diagram 100 demonstrates the frame member 102 in a first view 104 that demonstrates a longitudinal length of the frame member 102, in a second view 106 corresponding to an isometric view, in a first cross-sectional view 108 taken along the “A” reference, and in a second cross-sectional view 110 taken along the “B” reference. In the example of FIG. 3, the frame member 102 is formed as a “C-channel” corresponding to an approximate cross-sectional shape, such that the frame member has a top portion 112, a bottom portion 114 parallel with the top portion 112, and a lateral portion 116 that interconnects the top and bottom portions 112 and 114. The frame member 102 includes a plurality of kerf slits 118 arranged periodically along a longitudinal length of the frame member 102. The kerf slits 118 can be arranged, for example, at each of predetermined approximately equal distances along the longitudinal length of the frame member 102, with each of the kerf slits extending through the top portion 112 and through substantially an entirety of the lateral portion 116. Thus, the top portion 112 is interrupted by each of the kerf slits 118 along the longitudinal length of the frame member 102. The kerf slits 118 can therefore facilitate bending of the frame members 102, as described in greater detail herein.

The frame member 102 also includes a plurality of through-holes arranged as a through-hole pattern along the longitudinal length of the frame member 102. The through-hole pattern includes a precision through-hole 120 and a plurality of through-hole slots 122. As described herein, the term “precision” in the context of the through-holes refers to a high-degree of machined tolerance, such as to a precision of at least one-hundredth of an inch (e.g., between approximately 0.001″ and approximately 0.005″). While the through-hole 120 and the through-hole slots 122 are demonstrated as having rounded edges, it is to be understood that other types of through-holes (e.g., square or diamond) can be implemented. As an example, the precision through-hole 120 can be precision located in each of the X-axis and the Y-axis for radially aligning the radial antenna panel about the hub, as described in greater detail herein. As another example, the through-hole slots 122 can be precision located along the Y-axis for bending the frame member 102 on the associated panel bonding tool to provide an approximation of the reflector profile with respect to the top portion 112, as also described in greater detail herein. The through-hole slots 122 can be likewise implemented for coupling the resulting radial antenna panel to the ribs (e.g., the ribs 18 in the example of FIG. 1).

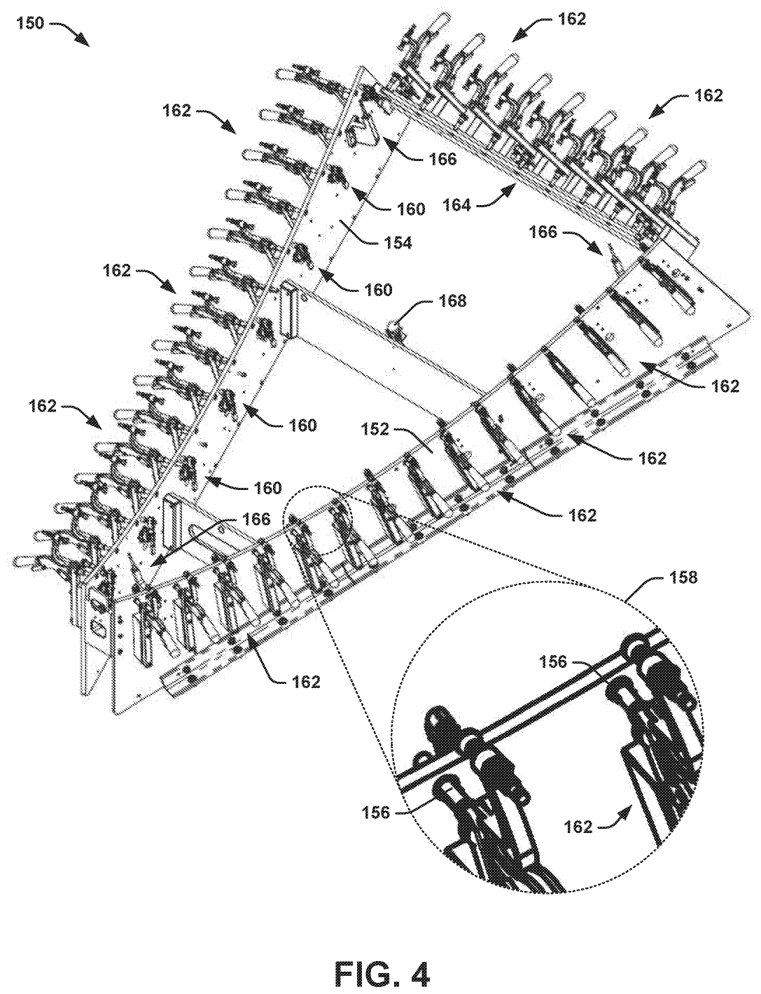

FIG. 4 illustrates an example of a panel bonding tool 150. The panel bonding tool 150 can be implemented for forming a radial antenna panel, such as the radial antenna panel in the example of FIG. 2, as described herein. Therefore, reference is to be made to the example of FIGS. 1-3 in the following description of the example of FIG. 4.

The panel bonding tool 150 includes a pair of sidewalls, demonstrated at 152 and 154, that includes a plurality of fastening features 156 that are configured to engage with the through-hole slots 122 of respective frame members 102 (the reference to which is interchangeable hereinafter with the frame members 56 and 58). In the example of FIG. 4, the fastening features 156 are demonstrated in greater detail in an exploded view 158 as spring-loaded sliding-pins that each extend through the respective one of the sidewalls 152 and 154 to engage (e.g., extend through) a respective one of the through-hole slots 122 of the respective one of the frame members 102. However, the fastening features 156 are not limited to the use of sliding pins, and can be any of a variety of ways of fastening the frame members 102 to the respective sidewalls 152 and 154 (e.g., other through-holes to receive a bolt).

As described previously, the frame members 56 and 58 are coupled to the sidewalls 152 and 154, respectively, during fabrication of a given radial antenna panel. In addition, the interconnect members 62 and 64 can be coupled to the frame members 56 and 58 (e.g., via an adhesive) to form the perimeter frame of the radial antenna panel. For example, the fastening features 156 are arranged along the sidewalls 152 and 154 in the reflector profile of the reflector antenna system 10. The panel bonding tool 150 therefore has a concave contour to a top side of the sidewalls 152 and 154 to which the frame members 56 and 58 are coupled. Accordingly, the panel bonding tool 150 can be arranged as a “female” panel bonding tool, as opposed to “male” panel bonding tools having a convex topside that is implemented for forming radial antenna panels in a typical reflector antenna assembly methodology. Therefore, when the respective frame members 56 and 58 are bent to facilitate coupling to the respective sidewalls 152 and 154, the top portion 112 of the respective frame member 102 can approximate the reflector profile of the reflector antenna system 10 (e.g., having a parabolic contour).

In the example of FIG. 4, the panel bonding tool 150 also includes inner clamps 160 that are periodically arranged on the interior surfaces of the respective sidewalls 152 and 154 and outer clamps 160 that are periodically arranged on the exterior surfaces of the respective sidewalls 152 and 154. The outer clamps 162 and inner clamps 160 are also arranged on an end wall 164 of the panel bonding tool 150. The panel bonding tool 150 also includes a set of parallel alignment pins 166 arranged between the sidewalls 152 and 154, as well as an adjustable center panel gravity stop 168. The inner clamps 160 can be engaged to secure the frame members 56 and 58 to the interior surfaces of the respective sidewalls 152 and 154 during formation of the perimeter frame on the panel bonding tool 150. Upon forming the perimeter frame via coupling the frame members 56 and 58 to the respective sidewalls 152 and 154 and coupling the interconnect members 62 and 64 to the frame members 56 and 58, an adhesive can be applied to the perimeter frame.

The reflector skin 60 can then be applied to the perimeter frame via the parallel alignment pins 166 being provided through the respective guide holes 66 formed in the reflector skin 60. As an example, the guide holes 66 can also be implemented to establish a fiducial plane for metrology inspection, such as measured to ideal surface profile accuracy, upon completion of the given radial antenna panel. The reflector skin 60 can be pressed onto the adhesive that is applied to the surfaces of the top portion 112 of the respective frame members 102. As an example, based on the relative dimension of the through-hole slots 122 relative to the surface of the top portion 112 of the frame members 102, and further relative to the dimension of the respective sidewalls 152 and 154, the lateral portion 116 of the frame members 102 can extend beyond the sidewalls 152 and 154, such that the top portion 112 of the frame members 102 can be elevated relative to a “top” surface of the sidewalls 152 and 154. Therefore, in response to the application of the reflector skin 60 to the adhesive on the top surface of the top portion 112, any potential “squeeze-out” of the adhesive will not contact any of the portions of the panel bonding tool 150. For example, application of a sufficient amount of adhesive to provide a squeeze-out may ensure that air gaps and voids are not present between the reflector skin 60 and frame members 102. Accordingly, the panel bonding tool 150 can remain clean without any of the adhesive from squeeze-out curing on any of the surfaces of the panel bonding tool 150.

The center panel gravity stop 168 can be adjusted to a predetermined height (e.g., via a screw adjustment). Therefore, when the reflector skin 60 is provided onto the adhesive on the perimeter frame, the convex surface (e.g., posterior side) of the reflector skin 60 can contact the center panel gravity stop 168 to ensure that the reflector skin 60 does not experience deformation from gravity-induced droop of the center portion of the reflector skin 60. Upon contacting the adhesive with the reflector skin 60, the outer clamps 162 can be engaged to provide pressure of the reflector skin 60 onto the adhesive while the adhesive cures. As an example, the adhesive can include one or more physical spacing elements to provide a standoff distance between the surface of the top portion 112 of the frame members 56 and 58 and the opposing surface of the reflector skin 60 separated by the adhesive. For example, the physical spacing element(s) can include beads, string, or other rigid physical objects to prevent direct contact between the surfaces of the reflector skin 60 and the frame members 56 and 58. As a result, the physical spacing element(s) can establish a minimum bonding thickness to establish sufficient bonding between the surfaces of the reflector skin 60 and the frame members 56 and 58. For example, the bonding thickness can vary from between approximately 0.012″ at an approximate center of the top portion 112 between the kerf slits 118 and approximately 0.054″ at the top portion 112 nearest the kerf slits 118 based on a parabolic reflector profile of the reflector skin 60. After the adhesive has cured, the outer clamps 162 can be disengaged and the resultant radial antenna panel can be removed from the panel bonding tool 150 (e.g., after removing the alignment pins 166 to facilitate sliding the radial antenna panel off of the panel bonding tool 150).

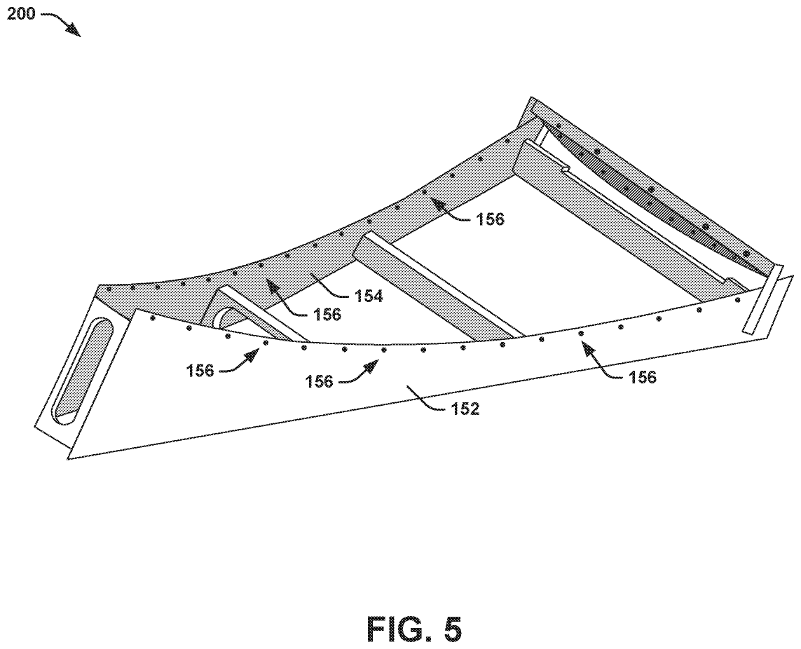

FIGS. 5-10 demonstrate the fabrication of a given radial antenna panel of the reflector antenna system 10 in greater detail. The radial antenna panel can correspond to the radial antenna panel of the example of FIG. 2 using the panel bonding tool 150 in the example of FIG. 4. Therefore, reference is to be made to the examples of FIGS. 1-4 in the following description of the examples of FIGS. 5-10. Additionally, like reference numbers are used in the examples of FIGS. 5-10 as provided in the examples of FIGS. 1-4.

FIG. 5 illustrates another example of a panel bonding tool 200. The panel bonding tool 200 can correspond to the panel bonding tool 150 in the example of FIG. 4. However, in the example of FIGS. 5-10, the panel bonding tool 200 and associated structures of the resultant radial antenna panel are demonstrated in a more simplistic manner. Therefore, certain components (e.g., the clamps 160 and 162) are omitted in the example of FIG. 5 for ease of explanation. The panel bonding tool 200 includes the pair of sidewalls 152 and 154, that each include the fastening features 156 that are configured to engage with the through-hole slots 122 of respective frame members 102. For example, the fastening features 156 are arranged along the sidewalls 152 and 154 in the reflector profile (e.g., a parabolic profile) of the reflector antenna system 10. The panel bonding tool 200 therefore has a concave contour to a top side of the sidewalls 152 and 154 to which the frame members 56 and 58 are coupled. Accordingly, the panel bonding tool 200 is arranged as a “female” panel bonding tool, as opposed to “male” panel bonding tools having a convex topside that is implemented for forming radial antenna panels in a typical reflector antenna assembly methodology.

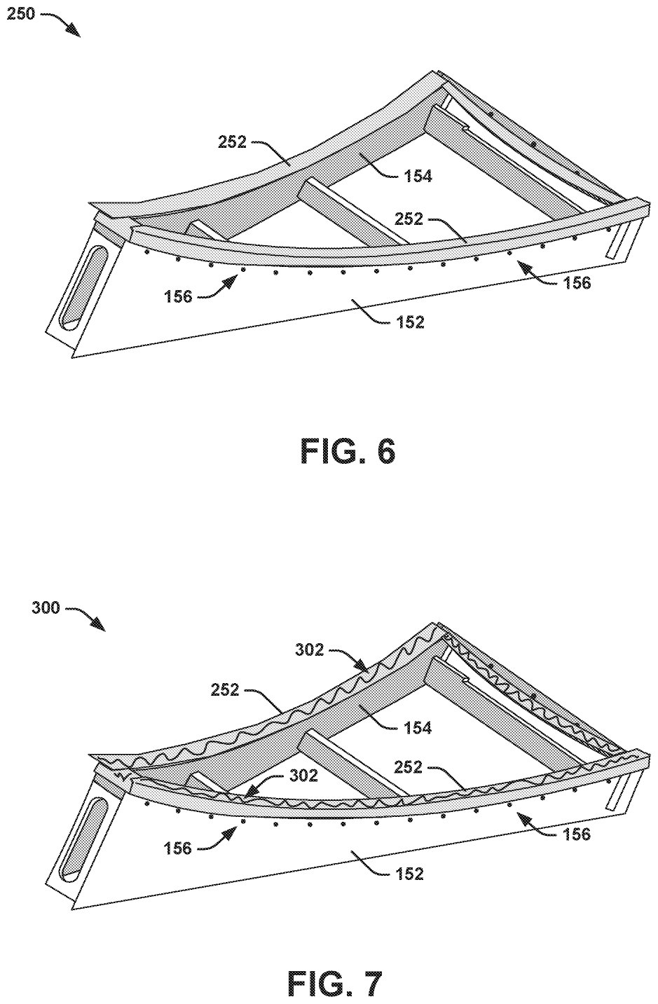

FIG. 6 illustrates an example diagram 250 of fabricating a radial antenna panel. The diagram 250 demonstrates the panel bonding tool 200 with a perimeter frame 252 attached thereto. The perimeter frame 252 can include the frame members 56 and 58 coupled to the respective sidewalls 152 and 154 via the fastening features 156 and the interconnect members 62 and 64 coupled to each of the frame members 56 and 58. For example, the frame members 56 and 58 are bent (e.g., via the kerf slits 118) to facilitate coupling to the respective sidewalls 152 and 154, such that the top portion 112 of the respective frame member 102 can approximate the reflector profile of the reflector antenna system 10 (e.g., having a parabolic contour). As an example, the fastening features 156 can correspond to spring-loaded sliding pins that can engage with the through-hole slots 122 of the frame members 102 to approximate the reflector profile, and the frame members 102 can be secured to the inner surfaces of the respective sidewalls 152 and 154 via the inner clamps 160.

FIG. 7 illustrates another example diagram 300 of fabricating a radial antenna panel. The diagram 300 demonstrates the panel bonding tool 200 with the perimeter frame 252 attached thereto. In the example of FIG. 7, an adhesive, demonstrated generally at 302, has been applied to the top surfaces of the perimeter frame 252, including the top surface of the top portion 112 of each of the frame members 102. The adhesive 302 can correspond to any of a variety of rapid-curing adhesives (e.g., with a working time of less than ten minutes and a curing time of approximately one hour or less). As described previously, based on the relative dimension of the through-hole slots 122 relative to the surface of the top portion 112 of the frame members 102, and further relative to the dimension of the respective sidewalls 152 and 154, the lateral portion 116 of the frame members 102 can extend beyond the sidewalls 152 and 154, such that the top portion 112 of the frame members 102 can be elevated relative to the top surface of the sidewalls 152 and 154.

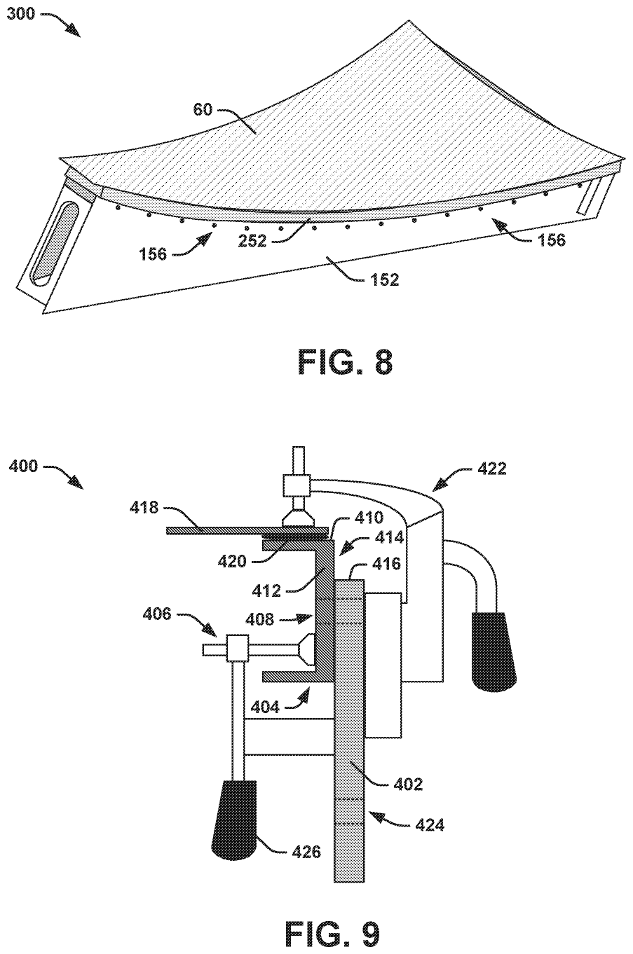

FIG. 8 illustrates another example diagram 350 of fabricating a radial antenna panel. The diagram 350 demonstrates the panel bonding tool 200 with the perimeter frame 252 attached thereto, and with the reflector skin 60 having been positioned in contact with the adhesive 302 on the perimeter frame 252. For example, the reflector skin 60 can have been applied to the perimeter frame 252 via the parallel alignment pins 166 being provided through the respective guide holes 66 (not shown in the example of FIG. 8) formed in the reflector skin 60. The reflector skin 60 can be pressed onto the adhesive 302 that is applied to the surfaces of the top portion 112 of the respective frame members 102. Because the top portion 112 of the frame members 102 can be elevated relative to the top surface of the sidewalls 152 and 154, as described previously, any potential “squeeze-out” of the adhesive 302 will not contact any of the portions of the panel bonding tool 200. Additionally, as described previously, the center panel gravity stop 168 can have been adjusted to a predetermined height (e.g., via a screw adjustment) prior to application of the reflector skin 60 to the adhesive 302. Therefore, when the reflector skin 60 is provided onto the adhesive on the perimeter frame, the convex surface (e.g., posterior side) of the reflector skin 60 can contact the center panel gravity stop 168 to ensure that the reflector skin 60 does not experience deformation from gravity-induced droop of the center portion of the reflector skin 60.

FIG. 9 illustrates another example diagram 400 of fabricating a radial antenna panel. The diagram 400 demonstrates a cross-sectional view of a sidewall 402 of the panel bonding tool 200, which can correspond to one of the sidewalls 152 and 154 of the panel bonding tool 200. The diagram 400 also demonstrates a cross-section of a frame member 404 (e.g., one of the frame members 56 and 58) secured to an inner surface of the sidewall 402 via an inner clamp 406 (e.g., one of the inner clamps 160). The frame member 404 and the sidewall 402 are demonstrated in the diagram 400 as including a common fastening, illustrated by dotted lines 408, corresponding to a fastening feature 156 engaging one of the through-hole slots 122 of the frame member 404 along a length of the respective sidewall 402 and frame member 404. As described previously, based on the relative dimension of the through-hole slots 122 relative to a top surface 410 of the frame member 404, and further relative to the dimension of the respective sidewall 402, a lateral portion 412 of the frame member 404 can extend beyond the sidewall 402, as demonstrated at 414. Therefore, the top surface 410 of the frame member 404 is demonstrated as elevated relative to a top surface 416 of the sidewall 402.

The diagram 400 also demonstrates a reflector skin 418 coupled to the top surface 410 of the frame member 404 via an adhesive 420. Because of the extension 414 of the frame member 404 relative to the sidewall 402, the adhesive 420 does not contact the sidewall 402 when any of the adhesive 420 squeezes out from between the top surface 410 of the frame member 404 and the reflector skin 418. Upon contacting the adhesive 420 with the reflector skin 418, the diagram 400 demonstrates an outer clamp 422 (e.g., of the outer clamps 162) that is engaged to provide pressure of the reflector skin 418 onto the adhesive 420 while the adhesive 420 cures. As described previously, the adhesive 420 can include one or more physical spacing elements to provide a standoff distance between the top surface 410 of the frame member 404 and the opposing surface of the reflector skin 418 separated by the adhesive 420. In addition, the diagram 400 demonstrates a release hole, illustrated by dotted lines 424, that facilitates release of the inner clamp 406 while the reflector skin 418 is adhered to the top perimeter frame that includes the frame member 404. Therefore, the release hole 424 provides access to a release handle, demonstrated at 426, for disengaging the inner clamp 406 for removing the perimeter frame from the panel bonding tool 200.

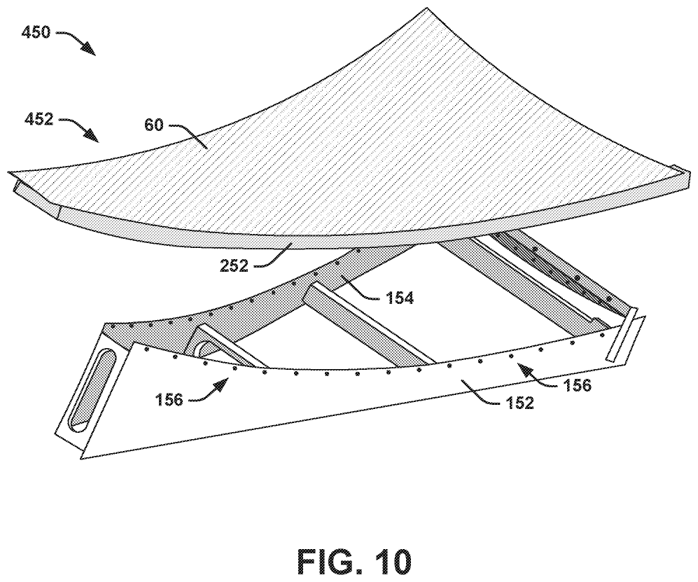

FIG. 10 illustrates another example diagram 450 of fabricating a radial antenna panel. The diagram 450 demonstrates a fabricated radial antenna panel 452 being removed from the panel bonding tool 200. The radial antenna panel 452 can therefore correspond to the radial antenna panel demonstrated in the example of FIG. 2. The radial antenna panel 452 can thus include the reflector skin 60 adhered to a perimeter frame that includes the frame members 56 and 58 and the interconnect members 62 and 64. The radial antenna panel 452 can be removed from the panel bonding tool 200 after the adhesive has cured, and after the inner clamps 160 and the outer clamps 162 have been disengaged, as well as the fastening features 156 on the sidewalls 152 and 154 of the panel bonding tool 200. The radial antenna panel 452 can thus correspond to one of the plurality of radial antenna panels 20 that can form the reflector antenna. As an example, each of the radial antenna panels 20 can be fabricated as described in the examples of FIGS. 4-10, similar to the radial antenna panel 452.

The methodology for fabricating the radial antenna panel 452 can therefore correspond to a significantly more efficient manner of fabricating a radial antenna panel than typical processes for fabricating a radial antenna panel. For example, as described previously, a typical radial antenna panel can be fabricated on a male panel bonding tool that implements a vacuum sealing system to vacuum secure a reflector skin onto a convex surface. Such a male panel bonding tool can be significantly more expensive to manufacture than the panel bonding tool 150 described herein based on additional materials and based on the inclusion of a vacuum system that is obviated for the design of the panel bonding tool 150. Additionally, for the typical fabrication methodology, the perimeter frame is assembled separately from the male panel bonding tool, and is applied to the adhesive that is provided on the surface of the vacuum-secured reflector skin. As a result, the perimeter frame in the typical fabrication methodology is formed in a manner that does not include fastening features on the panel bonding tool that pre-define the reflector profile for the resultant radial antenna panel. Instead, the perimeter frame of the typical fabrication methodology is bent to conform to the reflector profile contour of the reflector skin while it is vacuum-secured to the male panel bonding tool, directly onto the applied adhesive. Such an arrangement can be significantly more time consuming and can provide for more opportunities for errors in assembly of the perimeter frame and the securing of the perimeter frame to the adhesive. Furthermore, when the perimeter frame is pressed onto the adhesive that has been applied to the panel skin in the typical fabrication method, adhesive that squeezes out of the bonding of the perimeter frame to the reflector skin can flow over the perimeter of the reflector skin directly onto the surfaces of the male panel bonding tool. Accordingly, additional cleaning can be required in the typical fabrication methodology. However, the fabrication methodology described in the examples of FIGS. 4-10 mitigates the inefficiencies of the typical fabrication methodology, for the reasons described herein.

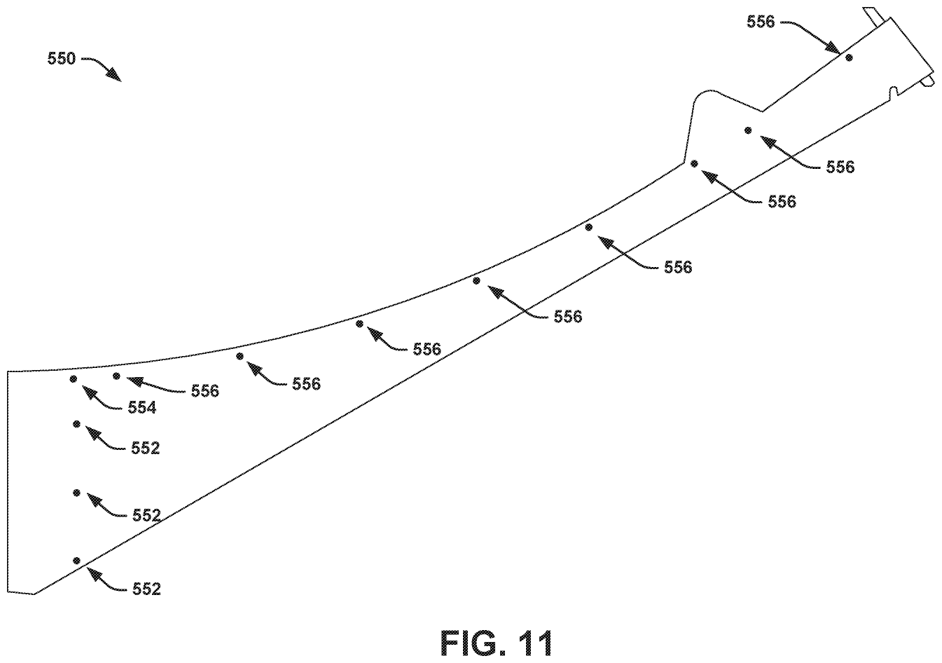

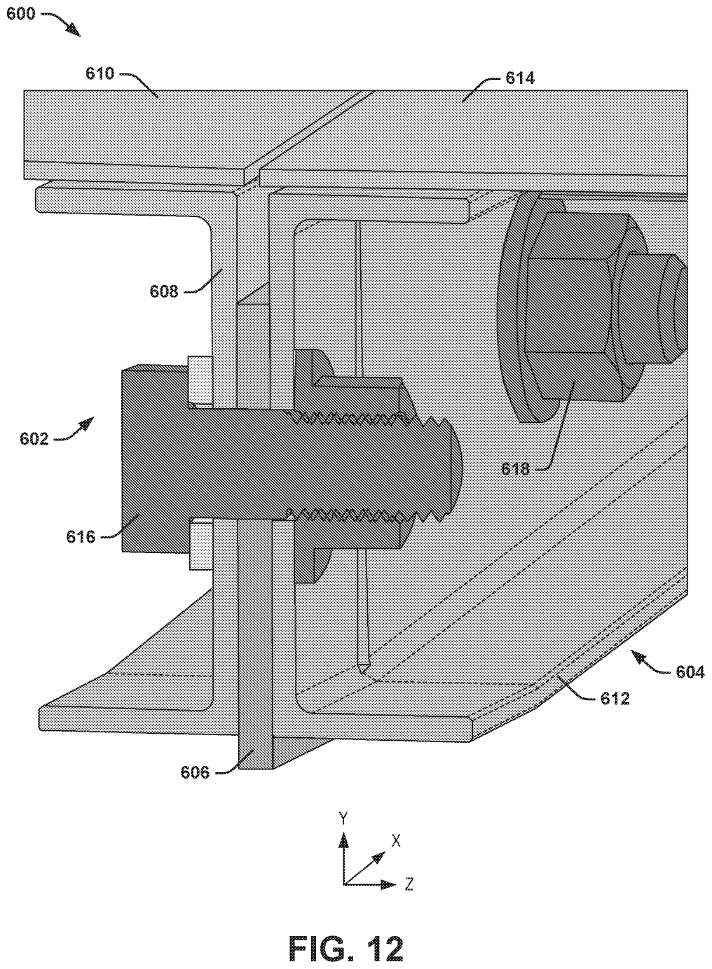

FIG. 11 illustrates an example of a rib 550 of an antenna system. The rib 550 can correspond to the ribs 18 of the reflector antenna 10 in the example of FIG. 1. Therefore, reference is to be made to the example of FIGS. 1-10 in the following description of the example of FIG. 12. The rib 550 can be coupled to the hub 16, and can be coupled to a pair of the radial antenna panels 20, such as the radial antenna panel 452 described previously.

In the example of FIG. 11, the rib 550 includes a plurality of through-holes, demonstrated as a first set of through-holes 552, an alignment through-hole 554, and a second set of through-holes 556. The first set of through-holes 552 can be implemented for coupling the rib 550 to the hub 16 (e.g., via a respective set of bolts). For example, the topmost and bottommost of the first set of through-holes 552 can provide for precision alignment of the rib 550 to the hub 16, and the innermost through-hole 552 can provide for an increased mounting strength of the rib 550 to the hub 16. The alignment through-hole 554 and the second set of through-holes 556 can define the reflector profile, similar to as described previously with respect to the fastening features 156 of the panel bonding tool 150. Therefore, the alignment through-hole 554 and the second set of through-holes 556 can have a profile that is approximately identical to the profile of the fastening features of the panel bonding tool 150. Accordingly, the alignment through-hole 554 and the second set of through-holes 556 can be implemented for coupling a given pair of radial antenna panels 20 to the rib 550 via the precision through-hole 120 and the through-hole slots 122 of the respective associated frame members 102.

For example, the precision through-hole 120 of a frame member 102 (e.g., corresponding to the first frame member 56) of a first radial antenna panel 20 and the precision through-hole 120 of a frame member 102 (e.g., corresponding to the second frame member 58) of a second radial antenna panel 20 can each be aligned with the alignment through-hole 554 of the rib 550. Therefore, a single through-bolt can couple the first and second radial antenna panels 20 to the rib 550 via the precision through-holes 120 and the alignment through-hole 554. For example, because the alignment through-hole 554 can be the through-hole most proximal to the hub, the coupling of first and second radial antenna panels 20 to the rib 550 via the precision through-holes 120 and the alignment through-hole 554 can radially align the radial antenna panels approximately uniformly about the center axis of the reflector antenna.

Similarly, each of the through-hole slots 122 of the frame member 102 (e.g., corresponding to the first frame member 56) of the first radial antenna panel 20 and the through-hole slots 122 of the frame member 102 (e.g., corresponding to the second frame member 58) of the second radial antenna panel 20 can each be aligned with each of the respective through-holes of the second set of through-holes 556 of the rib 550. Therefore, a single through-bolt can couple the first and second radial antenna panels 20 to the rib 550 via each of the through-hole slots 122 and each of the second set of through-holes 556, respectively. For example, each of the through-holes of the second set of through-holes 556 can be approximately aligned to a longitudinal center of the respective through-hole slots 122. Therefore, the radial antenna panels 20 can radially slide along coupling through-bolt via the respective through-hole slots 122 in response to expansion and contraction of the frame members 56 and 58 of the respective radial antenna panel 20. Accordingly, as described herein, the use of through-bolts for coupling the radial antenna panels 20 to the rib 550 can provide for a substantially simplistic and uniform manner of assembling the reflector antenna, without having to adjust the individual radial antenna panels to optimize the reflectivity of the resultant reflector antenna, as can be performed in typical reflector antennas.

FIG. 12 illustrates an example diagram 600 of coupling of radial antenna panels to a rib. The diagram 600 demonstrates an isometric cross-sectional view of the coupling of a first radial antenna panel 602 and a second radial antenna panel 604 to a rib 606. The first radial antenna panel 602 includes a frame member 608 and a reflector skin 610, and the second radial antenna panel 604 includes a frame member 612 and a reflector skin 614. The diagram 600 includes a cross-sectional view of a through-bolt 616 extending through a through-hole slot 122 of each of the frame member 608 and the frame member 612. The diagram 600 also includes a through-bolt 618 that can extend through a next through-hole slot 122 of each of the frame member 608 and the frame member 612.

The diagram also demonstrates that the lateral portion 116 of each of the frame members 608 and 612 extends farther along a Y-axis in Cartesian coordinate space than the rib 606. Thus, a peripheral edge of the rib 608 is not flush with the top surface of the top portions 112 of the respective frame members 610 and 614, resulting in the top surface of the top portions 112 of the respective frame members 610 and 614 being elevated greater than the peripheral edge of the rib 608 with respect to the Y-axis. Therefore, the reflector skins 610 and 614 can overlap and substantially cover the peripheral edge of the rib 608. As a result, the associated reflector antenna system 10 can have fewer interruptions in the reflective surface formed by the reflector skins 60 of each of the radial antenna panels 20, and can therefore exhibit a greater reflectivity for improved performance of the reflector antenna system 10.

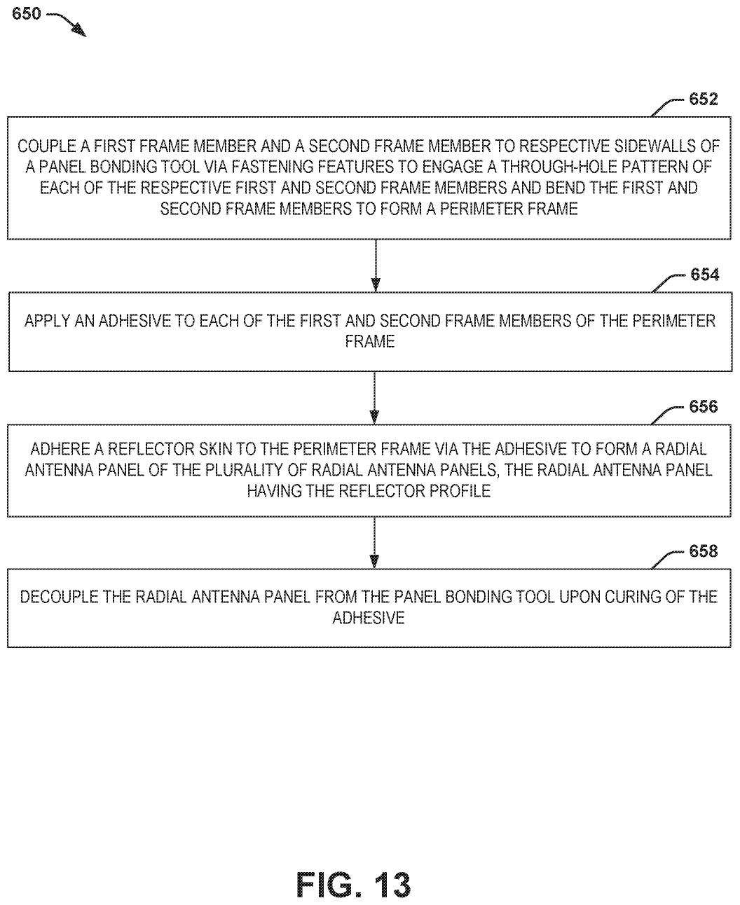

In view of the foregoing structural and functional features described above, a methodology in accordance with various aspects of the present invention will be better appreciated with reference to FIG. 13. While, for purposes of simplicity of explanation, the methodology of FIG. 13 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 13 illustrates an example of a method 650 for fabricating a radial antenna panel (e.g., the radial antenna panel 20) of a reflector antenna (e.g., the reflector antenna system 10). At 652, a first frame member (e.g., the first frame member 56) and a second frame member (e.g., the second frame member 58) are each coupled to respective sidewalls (e.g., the sidewalls 152 and 154) of a panel bonding tool (e.g., the panel bonding tool 200) via fastening features to engage a through-hole pattern (e.g., the through-holes 120 and 122) of each of the respective first and second frame members and bend the first and second frame members to form a perimeter frame (e.g., the perimeter frame 252). A longitudinal surface (e.g., of the lateral portion 116) of each of the first and second frame members can extend beyond a longitudinal surface of the respective sidewalls along a length of the respective sidewalls. The longitudinal surface of each of the first and second frame members can correspond to a reflector profile of the reflector antenna. At 654, an adhesive (e.g., the adhesive 302) is applied to each of the first and second frame members of the perimeter frame. At 656, a reflector skin (e.g., the reflector skin 60) is adhered to the perimeter frame via the adhesive to form a radial antenna panel of the plurality of radial antenna panels, the radial antenna panel having the reflector profile. At 658, the radial antenna panel is decoupled from the panel bonding tool upon curing of the adhesive.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims. Additionally, where the disclosure or claims recite “a.” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

1. A method for fabricating a radial antenna panel of a reflector antenna, the method comprising:
coupling a first frame member and a second frame member to respective sidewalls of a panel bonding tool via fastening features to engage a through-hole pattern of each of the respective first and second frame members and bend the first and second frame members to form a perimeter frame, wherein a longitudinal surface of each of the first and second frame members extends beyond a longitudinal surface of the respective sidewalls along a length of the respective sidewalls, and the longitudinal surface of each of the first and second frame members corresponds to a reflector profile of the reflector antenna;
applying an adhesive to each of the first and second frame members of the perimeter frame;
adhering a reflector skin to the perimeter frame via the adhesive to form a radial antenna panel of a plurality of radial antenna panels, the radial antenna panel having the reflector profile; and
decoupling the radial antenna panel from the panel bonding tool upon curing of the adhesive.

2. The method of claim 1, wherein each of the first and second frame members is arranged as a C-channel cross-section support rod.

3. The method of claim 1, wherein each of the first and second frame members comprises a plurality of kerf slits distributed along a longitudinal length to facilitate bending of the first and second frame members to the reflector profile via the coupling of the first and second frame members to the respective first and second sidewalls.

4. The method of claim 3, wherein applying the adhesive comprises applying the adhesive to a surface of each of the first and second frame members between each of the kerf slits.

5. The method of claim 1, wherein the through-hole pattern comprises a plurality of through-hole slots along a longitudinal length of each of the respective first and second frame members to accommodate fastening the first and second frame members to the panel bonding tool in the reflector profile.

6. The method of claim 5, wherein the plurality of through-hole slots are precision located along an axis transverse to a longitudinal length of each of the respective first and second frame members such that a portion of each of the first and second frame members along the axis is exposed when the first and second frame members are coupled to the respective sidewalls of the panel bonding tool.

7. The method of claim 5, wherein the through-hole pattern associated with each of the first and second frame members further comprises at least one precision through-hole configured to couple each the first and second frame members associated with the radial antenna panel to a respective pair of ribs, the ribs being coupled to a hub that defines an axial center of the reflector antenna, such that each of the pair of ribs interconnects the radial antenna panel to an adjacent radial antenna panel of the plurality of radial antenna panels.

8. The method of claim 7, wherein each of the first and second frame members comprises an axis transverse to a longitudinal length of the respective one of the first and second frame members that extends beyond a parallel cross-sectional axis associated with a respective one of the pair of ribs to which the respective one of the first and second frame members is coupled in an anterior direction of the reflector antenna.

9. The method of claim 1, wherein adhering the reflector skin comprises engaging a plurality of clamps associated with the panel bonding tool onto the reflector skin to provide pressure of the reflector skin onto the adhesive for curing the adhesive.

10. The method of claim 1, wherein coupling the first and second frame members to the panel bonding tool comprises:
coupling a nose bracket to a first end of each of the first and second frame members; and
coupling a corner bracket to a second end of each of the first and second frame members, the corner bracket having a length that is greater than the nose bracket to form the perimeter frame.

11. The method of claim 1, wherein adhering the reflector skin comprises aligning the reflector skin onto the perimeter frame via a plurality of parallel alignment pins associated with the panel bonding tool.

12. The method of claim 1, further comprising adjusting a height of a center panel gravity stop associated with the panel bonding tool, the center panel gravity stop being configured to contact a convex surface of the reflector skin when the reflector skin is adhered to the first and second frame members.

13. The method of claim 1, wherein applying the adhesive comprises applying an adhesive that comprises at least one physical spacing element to provide a standoff distance between a surface of the respective first and second frame members and a surface of the reflector skin separated by the adhesive.

14. A method for assembling the reflector antenna comprising the method of claim 1, wherein the radial antenna panel is a first radial antenna panel, the method for assembling the reflector antenna comprising:
coupling the first radial antenna panel to a first rib of a plurality of ribs via the through-hole pattern associated with the first frame member, the ribs being coupled to a hub that defines an axial center of the reflector antenna; and
coupling a second radial antenna panel to the first rib via a through-hole pattern associated with a respective second frame member of the second radial antenna panel.

15. A reflector antenna system comprising:
a hub at an axial center of a reflector antenna;
a plurality of radial antenna panels each comprising a plurality of frame members that form a perimeter frame of a respective one of the radial antenna panels and a respective reflector skin that is adhered to the respective perimeter frame via an adhesive, and each comprising a first through-hole pattern comprising a plurality of through-holes along a radial length of the respective frame member; and
a plurality of ribs, each of the ribs being coupled to and radially extending from the hub and interconnecting a pair of the respective plurality of radial antenna panels, each of the ribs comprising a second through-hole pattern along a radial length of the respective one of the ribs, the second through-hole pattern matching the first through-hole pattern, such that each of the plurality of ribs interconnects the pair of the radial antenna panels via fastening hardware extending through the corresponding first and second through-hole patterns of the respective rib and respective frame members, the corresponding first and second through-hole patterns collectively defining a reflector profile of the reflector antenna from the axial center to a periphery of the reflector antenna.

16. The system of claim 15, wherein each of the frame members is arranged as a C-channel cross-section support rod.

17. The system of claim 15, wherein each of the frame members comprise a plurality of kerf slits to facilitate bending of the respective frame members, the frame members of each of the radial antenna panels being coupled together to form the perimeter frame for the respective one of the radial antenna panels, wherein the reflector skin exhibits the reflector profile based on the bending of the first and second frame members.

18. The system of claim 17, wherein the perimeter frame of each of the radial antenna panels further comprises:
a nose bracket coupled to a first end of each of the frame members; and
a corner bracket coupled to a second end of each of the frame members, the corner bracket having a length that is greater than the nose bracket to form the perimeter frame.

19. The system of claim 17, wherein the adhesive is applied to a surface of each of the frame members between each of the kerf slits.

20. The system of claim 15, wherein the adhesive comprises at least one physical spacing element to provide a standoff distance between a surface of the respective frame members and a surface of the reflector skin separated by the adhesive.

21. The system of claim 15, wherein the through-hole pattern of each of the frame members comprises a precision through-hole and a plurality of through-hole slots.

22. The system of claim 21, wherein the precision through-hole of each of the frame members is located most proximal to the hub of the through-hole pattern along the radial length of the respective one of the frame members to radially align each of the radial antenna panels, wherein the plurality of through-hole slots are configured to accommodate thermal expansion and contraction on the respective one of the radial antenna panels along the radial length of a respective pair of ribs to which the respective one of the radial antenna panels is coupled.

23. The system of claim 22, wherein the plurality of through-hole slots are precision located along an axis transverse to a longitudinal length of each of the respective frame members such that a portion of each of the frame members along the axis is exposed when the frame members are coupled to the respective sidewalls of a panel bonding tool during fabrication of the respective one of the radial antenna panels.

24. The system of claim 15, wherein the through-hole pattern of each of the ribs is arranged substantially the same as an arrangement of fastening features of each of a plurality sidewalls of a panel bonding tool to which the frame members of a given one of the radial antenna panels are coupled via the through-hole pattern of each of the respective frame members to fabricate the respective one of the radial antenna panels.

25. The system of claim 24, wherein the panel bonding tool comprises a plurality of parallel alignment pins configured to align the reflector skin onto the adhesive applied to the frame members during fabrication of the respective one of the radial antenna panels.

26. The system of claim 25, wherein the panel bonding tool further comprises a plurality of clamps to provide pressure of the reflector skin onto the adhesive for curing the adhesive during the fabrication of the respective one of the radial antenna panels.

27. The system of claim 25, wherein the panel bonding tool further comprises a center panel gravity stop configured to contact a posterior surface of the reflector skin when the reflector skin is adhered to the frame members.

28. The system of claim 15, wherein each of the frame members comprises an axis transverse to a longitudinal length of the respective one of the frame members that extends beyond a parallel cross-sectional axis associated with a respective rib to which the respective one of the frame members is coupled in an anterior direction of the reflector antenna.
